(19) United States
(12) Patent Application Publication
(10) Pub. No.: US 2024/0359233 A1
(43) Pub. Date: Oct. 31, 2024

(54) LATTICE CURRENT COLLECTOR WITH BOTH FUNCTIONS OF STRAIN SENSING AND HIGH-TEMPERATURE CIRCUIT BREAKING AND MANUFACTURING METHOD THEREOF

(71) Applicant: HUAZHONG UNIVERSITY OF SCIENCE AND TECHNOLOGY, Hubei (CN)

(72) Inventors: Hongzhi Wu, Hubei (CN); Chunze Yan, Hubei (CN); Bin Su, Hubei (CN); Yusheng Shi, Hubei (CN)

(73) Assignee: HUAZHONG UNIVERSITY OF SCIENCE AND TECHNOLOGY, Hubei (CN)

(21) Appl. No.: 18/531,672

(22) Filed: Dec. 6, 2023

(30) Foreign Application Priority Data
Apr. 26, 2023 (CN) 202310494170.9
Sep. 30, 2023 (CN) 202311293470.7

(51) Int. Cl. B22F 5/10; B22F 1/10; B22F 10/12; B22F 10/28; H01M 4/72

(52) U.S. Cl. CPC B22F 5/10; B22F 1/10; B22F 10/12; B22F 10/28; H01M 4/72; B22F 2301/30; B33Y 70/10; B33Y 80/00

(57) ABSTRACT

The invention introduces a lattice current collector with both functions of strain sensing and high-temperature circuit breaking and a manufacturing method thereof. The method includes: S1: constructing a model of a three-dimensional lattice substrate; S2: taking a mixed powder as a raw material, performing printing according to the constructed model of the three-dimensional lattice substrate based on additive manufacturing technology to obtain the three-dimensional lattice substrate, the mixed powder including a flexible polymer powder and a permanent magnetic powder; S3: performing surface treatment on the three-dimensional lattice substrate, preparing a liquid metal, and transferring the liquid metal to a surface of the three-dimensional lattice substrate to form a conductive network; S4: magnetizing the three-dimensional lattice substrate to obtain a magnetic three-dimensional lattice substrate current collector, i.e., a lattice current collector with both functions of strain sensing and high-temperature circuit breaking.

### CROSS-REFERENCE TO RELATED APPLICATION

This application claims the priority benefit of China application serial no. 202310494170.9, filed on Apr. 26, 2023, and China application serial no. 202311293470.7, filed on Sep. 30, 2023. The entirety of each of the above-mentioned patent applications is hereby incorporated by reference herein and made a part of this specification.

### BACKGROUND

### Technical Field

The disclosure relates to the field of manufacturing of battery current collectors, and more specifically, to a lattice current collector with both functions of strain sensing and high-temperature circuit breaking and a manufacturing method thereof.

### Related Art

To reduce the dependence on fossil energy sources such as coal, petroleum, and natural gas, as a core energy storage technology, electrochemical energy storage technology has been constantly developing and innovating and has become a key technology to support the large-scale development of new energy and ensure the development of energy security in China. Lithium-ion batteries are one of the most promising new-generation energy storage devices, with advantages such as a high operating voltage, a high energy density, a long cycle life, and minimal environmental pollution. Lithium-ion batteries have been widely used in various fields such as military equipment, aerospace, electric vehicles, and digital products.

However, the use of lithium-ion batteries is also accompanied with certain safety risks, which mainly stem from thermal runaway within the lithium-ion battery. Thermal runaway is primarily triggered by internal short circuits, overcharging, and high temperatures of the battery. These three factors may trigger a series of side reactions such as decomposition of the solid electrolyte film on the surface of the negative electrode of the battery, generate heat and gas, cause the temperature and pressure of the battery to rise sharply, and ultimately lead to burning or even explosion.

The current collector is an important part forming the battery electrode structure and serves to carry active materials and collect and guide electrons to the external circuit. To enhance safety of batteries, at present, researchers have proposed to adopt a current collector of a three-dimensional lattice structure. The larger specific surface area of the three-dimensional lattice structure increases the contact area between the current collector and the active material, provides more reaction sites, and thus inhibits the growth of lithium dendrites formed of lithium metal in the deposition process of the negative electrode and prevents a short circuit. In addition, lithium ions may be dispersed and deposited in the macroscopic pores of the lattice current collector, which reduces the volume expansion of lithium metal and thus enhances battery safety.

The existing technology has certain limitations. The conventional three-dimensional lattice structure current collectors in lithium-ion batteries can effectively prevent the issue of internal short circuits. However, it does not adequately address the issues of battery bulging and deformation caused by overcharging inside the lithium-ion battery and battery burning and explosion caused by overheating. To overcome these issues, the disclosure introduces a lattice current collector with both functions of strain sensing and high-temperature circuit breaking and a manufacturing method thereof, which provide the conventional three-dimensional lattice structure current collector with both a sensing function for bulging and deformation and a circuit breaking function in case of high temperature and overheating.

### SUMMARY

To provide the conventional three-dimensional lattice structure current collector with the sensing function for bulging and deformation and the circuit breaking function in case of high temperature and overheating, the disclosure provides a lattice current collector with both functions of strain sensing and high-temperature circuit breaking and a manufacturing method thereof.

The method for manufacturing a lattice current collector with both functions of strain sensing and high-temperature circuit breaking adopts technical solutions below.

A method for manufacturing a lattice current collector with both functions of strain sensing and high-temperature circuit breaking includes steps below: S1: constructing a model of a three-dimensional lattice substrate; S2: taking a mixed powder as a raw material, performing printing according to the constructed model of the three-dimensional lattice substrate based on additive manufacturing technology to obtain the three-dimensional lattice substrate, the mixed powder including a flexible polymer powder and a permanent magnetic powder; S3: performing surface treatment on the three-dimensional lattice substrate, preparing a liquid metal, and transferring the liquid metal to a surface of the three-dimensional lattice substrate to form a conductive network; and S4: magnetizing the three-dimensional lattice substrate to obtain a magnetic three-dimensional lattice substrate current collector, which is a lattice current collector with both functions of strain sensing and high-temperature circuit breaking.

Preferably, in the S2, a mass fraction of the permanent magnetic powder in the mixed powder is 20% to 40%.

Preferably, in the S2, the flexible polymer powder is a thermoplastic polyurethane powder, and the permanent magnetic powder is at least one of a neodymium iron boron powder, a ferrite powder, an iron nickel powder, or an iron cobalt powder.

Preferably, in the S2, a particle size of the mixed powder is 20 μm to 100 μm.

Preferably, in the S2, a method for preparing the raw material includes: adding the mixed powder of the flexible polymer powder and the permanent magnetic powder to a ball mill, and adding a flow aid powder at the same time for mixing together.

Preferably, in the S2, the additive manufacturing technology is a selective laser sintering process, a vat photopolymerization (VP) process, or another additive manufacturing process suitable for polymer materials.

Preferably, in the S3, the surface treatment is performed on the three-dimensional lattice substrate by plasma surface oxidation or PMA adhesive treatment.

Preferably, in the S3, the liquid metal is a gallium-indium alloy or an indium-bismuth-tin alloy.

Preferably, in the S3, the three-dimensional lattice substrate is immersed in the liquid metal such that the liquid metal adheres to the surface of the three-dimensional lattice substrate, and the conductive network is formed upon completion of transfer.

The lattice current collector with both functions of strain sensing and high-temperature circuit breaking provided according to the disclosure adopts technical solutions below.

A lattice current collector with both functions of strain sensing and high-temperature circuit breaking is capable of deforming under an action of an external force, such that a magnetic flux passing through the conductive network changes and an induced electrical signal is generated at two ends of the lattice current collector accordingly, which realizes the function of strain sensing; and at an overly high external temperature, the liquid metal on a surface of a magnetic three-dimensional lattice substrate melts and thus destroys the conductive network, which realizes the function of high-temperature circuit breaking.

In summary of the above, the disclosure includes at least the following beneficial technical effects.

1. The three-dimensional lattice substrate is formed based on the additive manufacturing technology and is magnetized to obtain the magnetic three-dimensional lattice substrate, to the surface of which a layer of the liquid metal is further evenly adhered by a three-dimensional transfer method to obtain a lattice current collector with dual performance of force-electric conversion and resistance thermal response, so the current collector has both functions of strain sensing and high-temperature circuit breaking. When the battery bulges and deforms due to overcharging and gas generation inside the battery, the presence of deformation can be learned according to generation of an induced electrical signal, so corresponding safety measures can be taken. When the temperature rises to a certain level due to overheating, the liquid metal will flow, which destroys the conductive network and breaks the circuit of the current collector, so the surface of the battery becomes non-conductive and the battery stops operating under high temperature conditions. At the same time, this current collector also has the function of inhibiting dendrite growth and preventing short circuits. Thus, the current collector provided by the disclosure has the effect of comprehensively enhancing the safety of lithium-ion batteries.

2. The melting point of the liquid metal may be regulated by adjusting the ratio of its constituent elements. When the temperature exceeds the melting point of the liquid metal, the conductive network is destroyed and the current collector stops operating, which serves the purpose of battery safety, so the safety critical temperature is the melting point of the liquid metal. Thus, it is possible to achieve customization of the battery safety temperature to make it suitable for different application environments.

### BRIEF DESCRIPTION OF DRAWINGS

FIG. 1 is a schematic structure diagram of a current collector according to the disclosure.

FIG. 2 is a schematic diagram showing a principle of generation of an induced electrical signal by the current collector according to the disclosure.

FIG. 3 is a schematic diagram showing a principle of high-temperature circuit breaking of the current collector according to the disclosure.

FIG. 4 is a flowchart of a method according to the disclosure.

FIG. 5 is a schematic diagram showing a manufacturing process of the current collector according to the disclosure.

FIG. 6 is a comparison diagram showing a three-dimensional lattice substrate before and after being adhered with a liquid metal according to the disclosure.

FIG. 7 shows curves of changes in voltage over time generated by current collectors with different structural parameters under the action of cyclic external pressure in a force-electric conversion performance test according to the disclosure.

### DESCRIPTION OF EMBODIMENTS

To make the objectives, technical solutions, and advantages of the disclosure clearer, the disclosure will be further described in detail with reference to the accompanying drawings and examples. It should be understood that the specific embodiments and examples described herein only serve to interpret the disclosure rather than limit the disclosure.

One of the main cause of an internal short circuit in batteries is that lithium metal is prone to form lithium dendrites in the deposition process at the negative electrode, which results in a low Coulombic efficiency of the battery and a rapid capacity decay. When the growth of lithium dendrites reaches a certain level, they will pierce through the separator, causing the positive and negative electrodes to connect to each other and thus a short circuit.

When a lithium-ion battery is overcharged, excess lithium is embedded in the negative electrode, and excess lithium is removed from the positive electrode, which causes collapse of the crystal structure of the positive electrode active material of the battery. This process is also accompanied with generation of heat and release of active oxygen, leading to bulging, deformation, or even explosion of the battery cell.

When a lithium-ion battery is in a high-temperature environment, the inside the battery may severely overheat, leading to burning or even explosion of the lithium-ion battery.

At present, researchers have proposed to adopt a deposition main body with a three-dimensional lattice structure to homogenize the flow of lithium ions. This deposition main body, i.e., the current collector, is an important part forming the battery electrode structure and serves to carry active materials and collect and guide electrons to the external circuit. The larger specific surface area of the three-dimensional lattice structure increases the contact area between the current collector and the active material, provides more reaction sites, and thus inhibits the growth of lithium dendrites and prevents a short circuit. In addition, lithium ions may be dispersed and deposited in the macroscopic pores of the lattice current collector, which reduces the volume expansion of lithium metal and thus enhances battery safety.

Accordingly, on the basis of suppression of lithium dendrite growth and prevention of an internal short circuit in batteries by the three-dimensional current collector, research is conducted to further design and shape the material and structure of the three-dimensional current collector of the battery to enable the battery to have both functions of sensing battery bulging and deformation to take safety measures in advance and breaking and deactivating the circuit in high-temperature environments, which thus prevents thermal runaway caused by overcharging and high temperatures. Such research is an effective way to address battery safety issues, is a key and difficult area to be studied in this field, and is of great significance for achieving preventable and controllable safety of lithium-ion batteries.

The conventional three-dimensional current collector is a disordered porous structure, so it is difficult to actively design and regulate its performance and functions. Thus, it is required to design the three-dimensional current collector as an ordered structure to facilitate the control of structural characteristic parameters to achieve performance and function regulation.

Based on the principle of layer-by-layer manufacturing and stacking, the additive manufacturing technology is theoretically capable of forming any complex structures and is an effective means to achieve integrated preparation of the material, structure, and performance of an ordered lattice current collector. As a laser additive manufacturing technology based on powder bed fusion, selective laser sintering is suitable for the precise shaping of a complex three-dimensional lattice current collector and can achieve precise control of material and structural parameters of the current collector to thus regulate its performance and functions. Accordingly, in the embodiments of the disclosure, a polymer magnetic three-dimensional lattice substrate is formed based on the selective laser sintering process, and a layer of liquid metal is further adhered to the surface of the magnetic lattice substrate by a three-dimensional transfer method to obtain a lattice current collector with both functions of strain sensing and high-temperature circuit breaking.

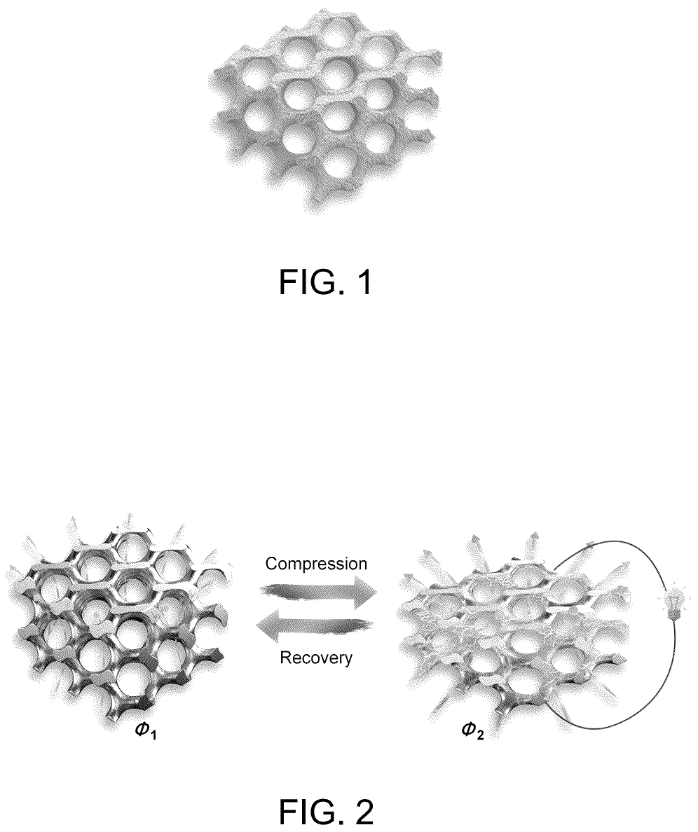

The disclosure will be further detailed with reference to FIG. 1 to FIG. 7.

As shown in FIG. 1, a lattice current collector with both functions of strain sensing and high-temperature circuit breaking has a structure including a magnetic three-dimensional lattice substrate and a conductive network. The structure of the magnetic three-dimensional lattice substrate is a pre-constructed three-dimensional lattice substrate model that is manufactured based on the additive manufacturing technology with a mixed powder formed by mixing a flexible polymer material and a permanent magnetic powder. The magnetic three-dimensional lattice substrate is capable of deforming under the action of an external force.

The conductive network is composed of a liquid metal transferred to the surface of the magnetic three-dimensional lattice substrate. The conductive network changes with changes in the magnetic three-dimensional lattice substrate, such that the magnetic flux passing through the conductive network changes and an induced electrical signal is generated at two ends of the current collector according to the law of electromagnetic induction.

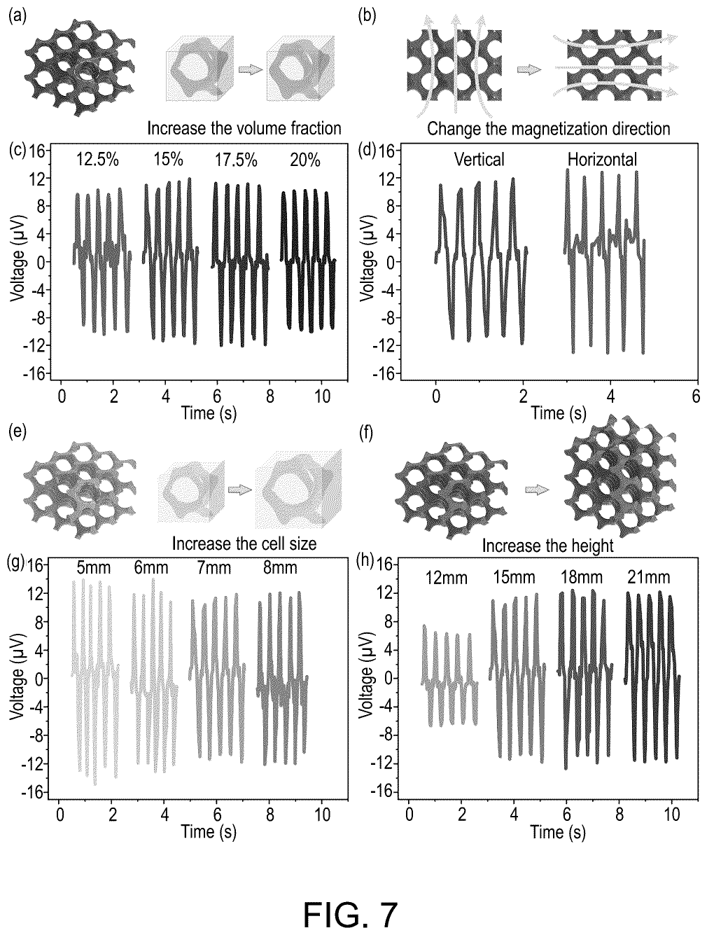

The lattice current collector has force-electric conversion performance due to the principle of electromagnetic induction and thus also has the function of stress/strain sensing. As shown in FIG. 2 and FIG. 7, when the battery deforms as a result of surface gas production or other causes, the magnetic flux in the current collector lattice structure changes. Due to the electromagnetic induction effect, an induced voltage is generated at two ends of the current collector accordingly, which realizes the sensing of deformation, and safety measures may be taken in advance. Moreover, the electrical signal is related to the volume fraction, cell size, and volume height of the current collector. Different strains are created at different positions of the current collector, and forces in different directions are applied to the current collector for testing.

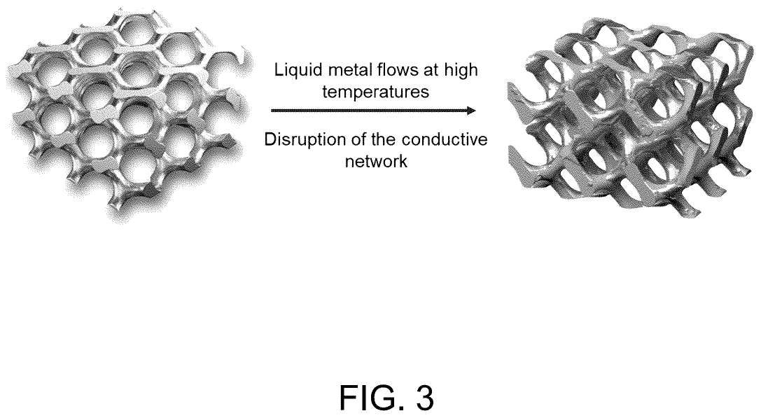

As shown in FIG. 3, due to the low melting point properties of the liquid metal, the lattice current collector also has resistance thermal response performance. That is, when the external temperature exceeds a specific value, the conductive network melts, flows, and is destroyed. As a result, the resistance of the lattice current collector increases sharply, and conductivity drops drastically, which breaks the circuit. Thus, the lattice current collector has a high-temperature circuit breaking function and can prevent safety hazards caused by overheating, burning, and explosion arising from high temperatures.

The disclosure further provides a method for manufacturing a lattice current collector with both functions of strain sensing and high-temperature circuit breaking.

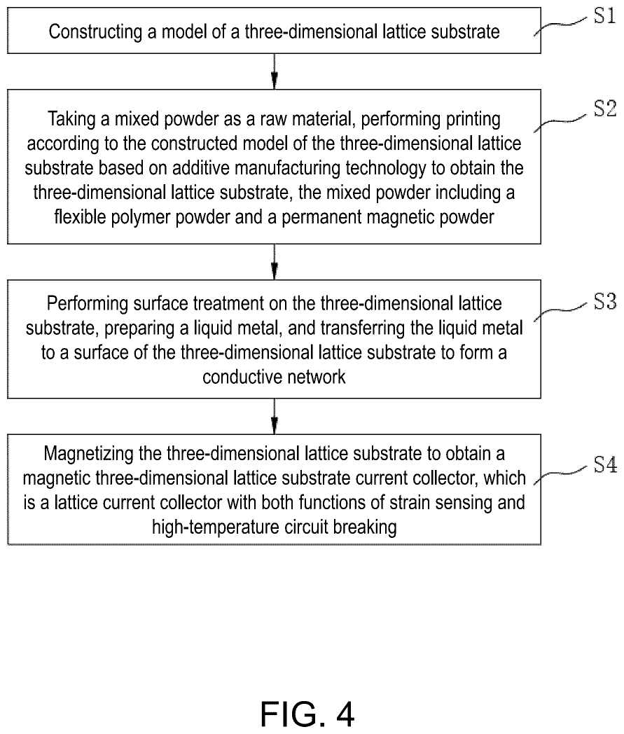

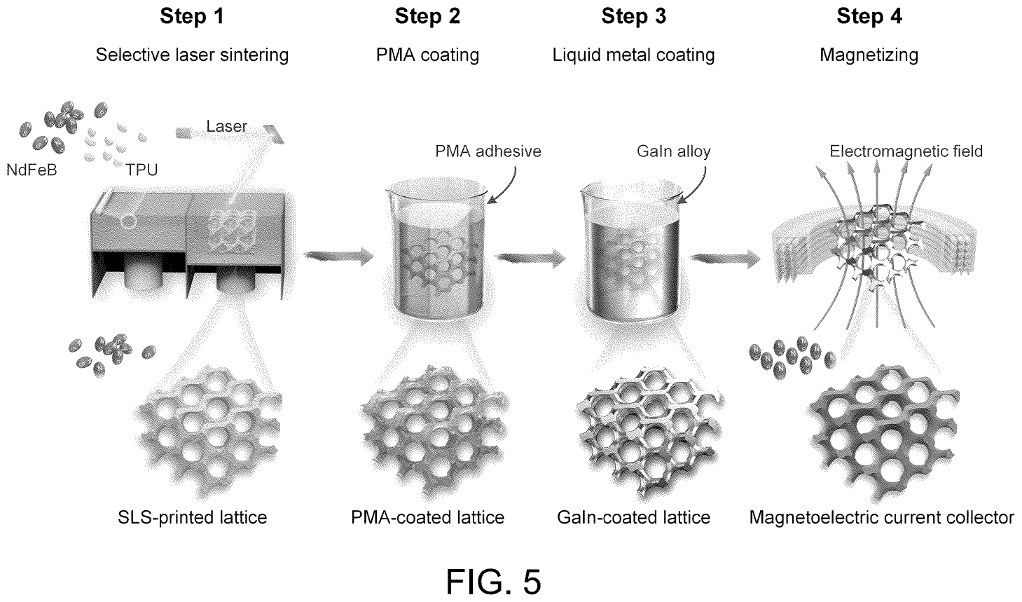

Referring to FIG. 4 and FIG. 5, the method for manufacturing a lattice current collector with both functions of strain sensing and high-temperature circuit breaking includes the following steps.

S1: Model construction: A model of a three-dimensional lattice substrate, specifically, a rectangular cuboid lattice structure, is constructed. The edge length of the rectangular cuboid is 15 mm to 25 mm, the volume fraction is 10% to 20%, and the cell size variation is 5 mm to 8 mm.

S2: Model printing: Taking a mixed powder as a raw material, printing is performed according to the constructed three-dimensional lattice substrate model (i.e., lattice structure) based on the additive manufacturing technology to obtain a three-dimensional lattice substrate. The mixed powder includes a flexible polymer powder and a permanent magnetic powder that are uniformly mixed.

The mass fraction of the permanent magnetic powder in the mixed powder is 20% to 40%, such as 20%, 30%, 40%, etc., and the mass fraction of the flexible polymer powder in the mixed powder is 60% to 80%, such as 80%, 70%, 60%, etc.

The flexible polymer powder is a thermoplastic polyurethane (TPU) powder, and the permanent magnetic powder is at least one of a neodymium iron boron powder, a ferrite powder, an iron nickel powder, or an iron cobalt powder. For example, the permanent magnetic powder may be a neodymium iron boron (NdFeB) powder, may be a neodymium iron boron powder and a ferrite powder, may be a neodymium iron boron powder, a ferrite powder, and an iron nickel powder, or may be a neodymium iron boron powder, a ferrite powder, an iron nickel powder, and an iron cobalt powder, etc.

The powder particle size of the flexible polymer powder and the permanent magnetic powder is 20 μm to 100 μm in a normal distribution (uniformly mixed).

During the preparation of the raw material, the mixed powder of the flexible polymer powder and the permanent magnetic powder is added to a ball mill, and a flow aid powder is added for mixing at the same time. The flow aid powder is a fumed silica powder. 1.2 g of the fumed silica powder is added to each 100 g of the mixed powder. The three powders are mixed in a planetary ball mill at a rate of 600 revolutions per minute for 3 minutes to achieve uniform mixing. Raw materials with a uniform color are prepared, with the mass fraction of the permanent magnetic powder being 20%, 30%, and 40%, respectively.

The additive manufacturing technology is the selective laser sintering (SLS) process, the vat polymerization process, including stereolithography apparatus (SLA) and digital light processing (DLP) processes, or other additive manufacturing processes suitable for polymer materials. This application preferably adopts the selective laser sintering process. The prepared raw material described above is suitable for the selective laser sintering process to form a three-dimensional lattice substrate. Specifically, the selective laser sintering equipment is a 30 W CO₂ laser (wavelength λ=10.6 μm). In the forming process, the neodymium iron boron powder has no magnetism and requires magnetization after formation so that the powder will have permanent magnetism. Thus, the neodymium iron boron powder does not stick to the powder spreading roller and affect the forming process.

S3: Surface treatment is performed on the three-dimensional lattice substrate to enhance the adhesion effect of the liquid metal, a liquid metal is prepared, and the liquid metal is transferred to the surface of the three-dimensional lattice substrate to form a conductive network. Specifically, the surface of the three-dimensional lattice substrate is treated by plasma surface oxidation or PMA adhesive treatment. Preferably, the treatment is PMA (poly(methyl acrylate)) adhesive treatment.

The liquid metal is prepared. In this application, the liquid metal is a gallium-indium alloy or an indium-bismuth-tin alloy. Preferably, a gallium-indium alloy is used. The gallium-indium alloy is in the liquid state at room temperature, with a melting point of 15.7° C.±1° C. The melting point of the gallium-indium alloy may be customized according to the ratio of gallium and indium elements. The customized melting points are 3° C., 5° C., 8° C., 11° C., 12° C., 13° C., 15.7° C., 16° C., 17° C., 20° C., 25° C., and 30° C.

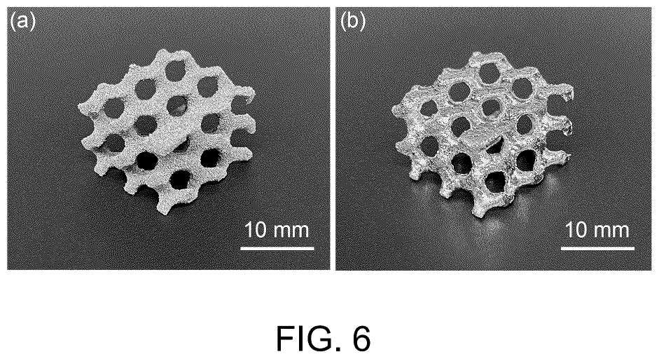

The liquid metal is transferred to the surface of the three-dimensional lattice substrate. Specifically, the three-dimensional lattice substrate is immersed in the liquid gallium-indium alloy, such that the liquid metal adheres to the surface of the three-dimensional lattice substrate. Upon completion of the transfer, the conductive network is formed (refer to FIG. 6).

S4: The three-dimensional lattice substrate is magnetized to obtain a magnetic three-dimensional lattice substrate. Specifically, the three-dimensional lattice substrate is magnetized with pulse magnetizing equipment. The magnetic field direction of each neodymium iron boron particle is instantly aligned with the direction of the external magnetic field, and thus the lattice structure obtains permanent magnetism and is capable of generating a magnetic field.

To better illustrate the implementation details of the disclosure, the following examples are provided to further describe the disclosure. However, it should be understood that the content in the examples does not serve as a further limitation on the scope of protection of the disclosure.

### Example 1

A method for manufacturing a lattice current collector with both functions of strain sensing and high-temperature circuit breaking includes the following steps.

(1) A lattice structure model is constructed. The outer contour size of the lattice structure model is 20 mm×20 mm×15 mm, where the cell size is 8 mm, and the volume fraction is 15%.

(2) A raw material is prepared with a neodymium iron boron (NdFeB) powder, a thermoplastic polyurethane (TPU) powder, and a fumed silica powder as a rheological aid. In this example, the mass fraction of the neodymium iron boron powder is 20%, and the particle sizes of the neodymium iron boron powder, the thermoplastic polyurethane powder, and the fumed silica powder are all 20 μm. The three powders are mixed in a planetary ball mill at a rate of 600 revolutions per minute for 3 minutes to obtain the raw material with a uniform color.

(3) According to the model constructed in step (1), the raw material obtained in step (2) is shaped and printed based on the selective laser sintering process to obtain a three-dimensional lattice substrate. The surface of the three-dimensional lattice substrate is treated by PMA adhesive treatment.

(4) A liquid metal is prepared by selecting a gallium-indium alloy with a melting point of 15.7° C., and the liquid metal is placed in a crucible.

(5) The three-dimensional lattice substrate is placed in the crucible, such that its surface is adhered with the liquid metal. The liquid metal adheres to the surface of the three-dimensional lattice substrate under the action of gravity, and the three-dimensional lattice substrate is rotated until the liquid metal adheres evenly to its surface.

(6) The three-dimensional lattice substrate is magnetized with pulse magnetizing equipment to obtain a magnetic three-dimensional lattice substrate current collector.

### Example 2

A method for manufacturing a lattice current collector with both functions of strain sensing and high-temperature circuit breaking includes the following steps.

(1) A lattice structure model is constructed. The outer contour size of the lattice structure model is 20 mm×20 mm×15 mm, where the cell size is 7 mm, and the volume fraction is 12.5%.

(2) A raw material is prepared with a neodymium iron boron (NdFeB) powder, a thermoplastic polyurethane (TPU) powder, and a fumed silica powder as a rheological aid. In this example, the mass fraction of the neodymium iron boron powder is 20%, and the particle sizes of the neodymium iron boron powder, the thermoplastic polyurethane powder, and the fumed silica powder are all 40 μm. The three powders are mixed in a planetary ball mill at a rate of 600 revolutions per minute for 3 minutes to obtain a raw material with a uniform color.

(3) According to the model constructed in step (1), the raw material obtained in step (2) is shaped and printed based on the selective laser sintering process to obtain a three-dimensional lattice substrate. The surface of the three-dimensional lattice substrate is treated by PMA adhesive treatment.

(4) A liquid metal is prepared by selecting a gallium-indium alloy with a melting point of 3° C., and the liquid metal is placed in a crucible.

(5) The three-dimensional lattice substrate is placed in the crucible, such that its surface is adhered with the liquid metal. The liquid metal adheres to the surface of the three-dimensional lattice substrate under the action of gravity, and the three-dimensional lattice substrate is rotated until the liquid metal adheres evenly to its surface.

(6) The three-dimensional lattice substrate is magnetized with pulse magnetizing equipment to obtain a magnetic three-dimensional lattice substrate current collector.

### Example 3

A method for manufacturing a lattice current collector with both functions of strain sensing and high-temperature circuit breaking includes the following steps.

(1) A lattice structure model is constructed. The outer contour size of the lattice structure model is 10 mm×10 mm×15 mm, where the cell size is 6 mm, and the volume fraction is 20%.

(2) A raw material is prepared with a neodymium iron boron (NdFeB) powder, a thermoplastic polyurethane (TPU) powder, and a fumed silica powder as a rheological aid. In this example, the mass fraction of the neodymium iron boron powder is 30%, and the particle sizes of the neodymium iron boron powder, the thermoplastic polyurethane powder, and the fumed silica powder are all 20 μm. The three powders are mixed in a planetary ball mill at a rate of 600 revolutions per minute for 3 minutes to obtain the raw material with a uniform color.

(3) According to the model constructed in step (1), the raw material obtained in step (2) is shaped and printed based on the selective laser sintering process to obtain a three-dimensional lattice substrate. The surface of the three-dimensional lattice substrate is treated by PMA adhesive treatment.

(4) A liquid metal is prepared by selecting a gallium-indium alloy with a melting point of 20° C., and the liquid metal is placed in a crucible.

(5) The three-dimensional lattice substrate is placed in the crucible, such that its surface is adhered with the liquid metal. The liquid metal adheres to the surface of the three-dimensional lattice substrate under the action of gravity, and the three-dimensional lattice substrate is rotated until the liquid metal adheres evenly to its surface.

(6) The three-dimensional lattice substrate is magnetized with pulse magnetizing equipment to obtain a magnetic three-dimensional lattice substrate current collector.

### Example 4

A method for manufacturing a lattice current collector with both functions of strain sensing and high-temperature circuit breaking includes the following steps.

(1) A lattice structure model is constructed. The outer contour size of the lattice structure model is 15 mm×15 mm×15 mm, where the cell size is 5 mm, and the volume fraction is 10%.

(2) A raw material is prepared with a neodymium iron boron (NdFeB) powder, a thermoplastic polyurethane (TPU) powder, and a fumed silica powder as a rheological aid. In this example, the mass fraction of the neodymium iron boron powder is 40%, and the particle sizes of the neodymium iron boron powder, the thermoplastic polyurethane powder, and the fumed silica powder are all 100 μm. The three powders are mixed in a planetary ball mill at a rate of 600 revolutions per minute for 3 minutes to obtain the raw material with a uniform color.

(3) According to the model constructed in step (1), the raw material obtained in step (2) is shaped and printed based on the selective laser sintering process to obtain a three-dimensional lattice substrate. The surface of the three-dimensional lattice substrate is treated by PMA adhesive treatment.

(4) A liquid metal is prepared by selecting a gallium-indium alloy with a melting point of 30° C., and the liquid metal is placed in a crucible.

(5) The three-dimensional lattice substrate is placed in the crucible, such that its surface is adhered with the liquid metal. The liquid metal adheres to the surface of the three-dimensional lattice substrate under the action of gravity, and the three-dimensional lattice substrate is rotated until the liquid metal adheres evenly to its surface.

(6) The three-dimensional lattice substrate is magnetized with pulse magnetizing equipment to obtain a magnetic three-dimensional lattice substrate current collector.

The above are all preferred embodiments and examples of the disclosure and do not limit the scope of protection of the disclosure. Thus, any equivalent changes made according to the structure, shape, and principle of the disclosure should be included within the scope of protection of the disclosure.

What is claimed is:

1. A method for manufacturing a lattice current collector with both functions of strain sensing and high-temperature circuit breaking, the method comprising steps below:
a step of S1: constructing a model of a three-dimensional lattice substrate;
a step of S2: taking a mixed powder as a raw material, performing printing according to the constructed model of the three-dimensional lattice substrate based on additive manufacturing technology to obtain the three-dimensional lattice substrate, wherein the mixed powder comprises a flexible polymer powder and a permanent magnetic powder;
a step of S3: performing a surface treatment on the three-dimensional lattice substrate, preparing a liquid metal, and transferring the liquid metal to a surface of the three-dimensional lattice substrate to form a conductive network; and
a step of S4: magnetizing the three-dimensional lattice substrate to obtain a magnetic three-dimensional lattice substrate current collector, which is a lattice current collector with both functions of strain sensing and high-temperature circuit breaking.

2. The method for manufacturing a lattice current collector with both functions of strain sensing and high-temperature circuit breaking according to claim 1, wherein, in the step of S2, a mass fraction of the permanent magnetic powder in the mixed powder is 20% to 40%.

3. The method for manufacturing a lattice current collector with both functions of strain sensing and high-temperature circuit breaking according to claim 1, wherein, in the step of S2, the flexible polymer powder is a thermoplastic polyurethane powder, and the permanent magnetic powder is at least one of a neodymium iron boron powder, a ferrite powder, an iron nickel powder, or an iron cobalt powder.

4. The method for manufacturing a lattice current collector with both functions of strain sensing and high-temperature circuit breaking according to claim 1, wherein, in the S2, a particle size of the mixed powder is 20 μm to 100 μm.

5. The method for manufacturing a lattice current collector with both functions of strain sensing and high-temperature circuit breaking according to claim 1, wherein, in the step of S2, a method for preparing the raw material comprises: adding the mixed powder of the flexible polymer powder and the permanent magnetic powder to a ball mill, and adding a flow aid powder at the same time for mixing together.

6. The method for manufacturing a lattice current collector with both functions of strain sensing and high-temperature circuit breaking according to claim 1, wherein, in the step of S2, the additive manufacturing technology is a selective laser sintering process, a vat photopolymerization (VP) process, or another additive manufacturing process suitable for polymer materials.

7. The method for manufacturing a lattice current collector with both functions of strain sensing and high-temperature circuit breaking according to claim 1, wherein, in the step of S3, the surface treatment is performed on the three-dimensional lattice substrate by a plasma surface oxidation or a PMA adhesive treatment.

8. The method for manufacturing a lattice current collector with both functions of strain sensing and high-temperature circuit breaking according to claim 1, wherein, in the step of S3, the liquid metal is a gallium-indium alloy or an indium-bismuth-tin alloy.

9. The method for manufacturing a lattice current collector with both functions of strain sensing and high-temperature circuit breaking according to claim 1, wherein, in the step of S3, the three-dimensional lattice substrate is immersed in the liquid metal such that the liquid metal adheres to the surface of the three-dimensional lattice substrate, and the conductive network is formed upon completion of transfer.

10. A lattice current collector with both functions of strain sensing and high-temperature circuit breaking, manufactured by the method for manufacturing a lattice current collector with both functions of strain sensing and high-temperature circuit breaking according to claim 1, wherein the lattice current collector is capable of deforming under an action of an external force, such that a magnetic flux passing through the conductive network changes and an induced electrical signal is generated at two ends of the lattice current collector accordingly, which realizes the function of strain sensing; and at an overly high external temperature, the liquid metal on a surface of a magnetic three-dimensional lattice substrate melts and thus destroys the conductive network, which realizes the function of high-temperature circuit breaking.
